(19) United States
(12) Patent Application Publication
(10) Pub. No.: US 2009/0293985 A1
(43) Pub. Date: Dec. 3, 2009

(54) BEVERAGE BOTTLE FILLING MACHINE FOR FILLING BOTTLES WITH FRUIT JUICES, BEVERAGE FILLING ELEMENT IN A BEVERAGE BOTTLE FILLING MACHINE WITH SUCH BEVERAGE FILLING ELEMENTS FOR FILLING BOTTLES OR SIMILAR CONTAINERS WITH FRUIT JUICES, AND A BEVERAGE BOTTLE FILLING ELEMENT FOR FILLING BOTTLES OR SIMILAR CONTAINERS WITH FRUIT JUICES

(76) Inventors: Volker TILL, Hofheim am Taunus (DE); Dieter-Rudolf KRULITSCH, Bad Kreuznach (DE)

Correspondence Address: NILS H. LJUNGMAN & ASSOCIATES, P. O. BOX 130, GREENSBURG, PA, 15601-0130, US

(21) Appl. No.: 12/323,579

(22) Filed: Nov. 26, 2008

Related U.S. Application Data
(63) Continuation-in-part of application No. PCT/EP2007/004504, filed on May 22, 2007.

(30) Foreign Application Priority Data
May 29, 2006 (DE) 10 2006 025 229.2

(51) Int. Cl. B65B 3/04; B67C 3/28

(52) U.S. Cl. 141/1; 141/115

(57) ABSTRACT

A beverage bottle filling machine for filling bottles with fruit juices, beverage filling element in a beverage bottle filling machine with such beverage filling elements for filling bottles or similar containers with fruit juices, and a beverage bottle filling element for filling bottles or similar containers with fruit juices. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP/004504, filed on May 22, 2007, which claims priority from Federal Republic of Germany Patent Application No. 10 2006 025 229.2, filed on May 29, 2006. International Patent Application No. PCT/EP/004504 was pending as of the filing date of this application. The United States was an elected state in International Patent Application No. PCT/EP2007/004504.

### BACKGROUND

1. Technical Field

The present application relates to a filling element and the filling machine with such filling elements.

2. Background Information

Background information is for informational purposes only and does not necessarily admit that subsequently mentioned information and publications are prior art.

Some filling elements fill a liquid product in a container. Some filling elements have a gas seal in the vicinity of the respective discharge opening to restrict or minimize the filling element from dripping after closure of the filling valve. In some filling elements, the gas seal is designed so that a portion of the product channel upstream of the discharge opening of the filling element remains filled with the liquid product after closure of the filling valve without the liquid product leaking from the discharge opening and without the filling element dripping. In the simplest case, the gas seal is realized as a sieve-like structure where the cross-section of the openings is chosen such that the surface tension of the liquid product is sufficient to prevent dripping and/or to retain the product head in the product channel upstream of the discharge opening.

### OBJECT OR OBJECTS

The object of the present application is to describe a filling element that functions reliably even when filling a product having solid components or pieces in a liquid, liquid-viscous or low-viscosity-viscous phase.

### SUMMARY

A filling element for achieving this object is described according to the present application as a filling element for the filling of a product, for example a product that in a liquid phase contains more solid components. The filling element has at least one product channel in a housing, which product channel can be connected via an inlet opening on one end to a reservoir for the product, and also has at the other end a discharge opening for the discharge of the product into a container. The filling element can be positioned by control action between an initial operating state that restricts or minimizes the discharge of product and a second opened operating state. A filling machine is the object of a filling machine, for example a rotary-type filling machine with a plurality of filling elements, in which the filling elements are the filling elements according to the present application.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Further possible embodiments are disclosed according to the present application. One possible embodiment of the present application is described in greater detail below illustrated with the accompanying drawings, in which:

FIGS. 1 through 4 each show a very simplified representation of a filling element of a filling machine for filling a liquid product comprising solid components or pieces, together with a bottle-like container, each in different operating states;

FIGS. 5 through 7 show the filling valve of the filling element in different operating states;

FIG. 8 shows an enlarged representation of the lift-out gas seal in the vicinity of the discharge opening; and

FIG. 9 shows schematically the main components of one possible embodiment example of a system for filling containers, specifically, a beverage bottling plant for filling bottles with at least one liquid beverage, in accordance with at least one possible embodiment, in which system or plant could possibly be utilized at least one aspect, or several aspects, of the embodiments disclosed herein.

### DESCRIPTION OF EMBODIMENT OR EMBODIMENTS

In the Figures, 1 is a filling element of a filling machine, for example a rotary-type filling machine having a plurality of these filling elements 1 arranged either on the circumference of a driven rotor rotating around a vertical machine axis or on the circumference of an annular vessel or reservoir 2 provided on this rotor.

The filling element 1 serves to fill a liquid product 3 comprising more solid components or pieces 4, e.g., for filling a fruit preparation (e.g., juice with pieces of fruit) into containers 5. During the filling process (free jet filling), these containers 5 stand upright, i.e. with the container axis vertical and coaxial or nearly coaxial with a filling element axis FA, and below the respective filling element 1 on a container conveyor 6 so that the container opening 5.1 is opposite to and at some distance from a discharge opening 7 of the filling element 1.

A housing 8 of the filling element 1 comprises a product channel or channel 9, which is connected at one end to an outlet or connecting opening 10 at the base of the annular vessel 2 and whose other end forms the discharge opening. In the embodiment shown, the product channel 9 comprises multiple channel sections. Beginning from the connecting opening 10, these are a channel section 9.1 forming a valve space for a downstream filling valve 11 described in greater detail below; a horizontal or essentially horizontal channel section 9.2; a channel section 9.3; and a channel section 9.4 that transitions into the discharge opening 7. The channel sections 9.3 and 9.4 are coaxial and also coaxial to the vertical filling element axis FA. Channel section 9.4 has a reduced cross-section relative to channel section 9.3.

Channel section 9.1 is in the upper region of a housing section 8.1 extending vertically downward from the annular vessel 2; channel section 9.2 is in a housing section 8.2 extending horizontally or essentially horizontally; and channel sections 9.3 and 9.4 are in a vertical housing section 8.3, which, relative to the vertical machine axis, is radially offset toward the outside of the annular vessel 2 and the opposing housing section 8.1.

The filling valve or valving arrangement 11 comprises among other things a valve body 12, on the upper end of which as shown in the figures is a valve plunger 13, which extends in housing section 8.1 and is arranged axially parallel or virtually parallel to the filling element axis FA and, in the embodiment shown, coaxial with the axis of the connecting opening 10.

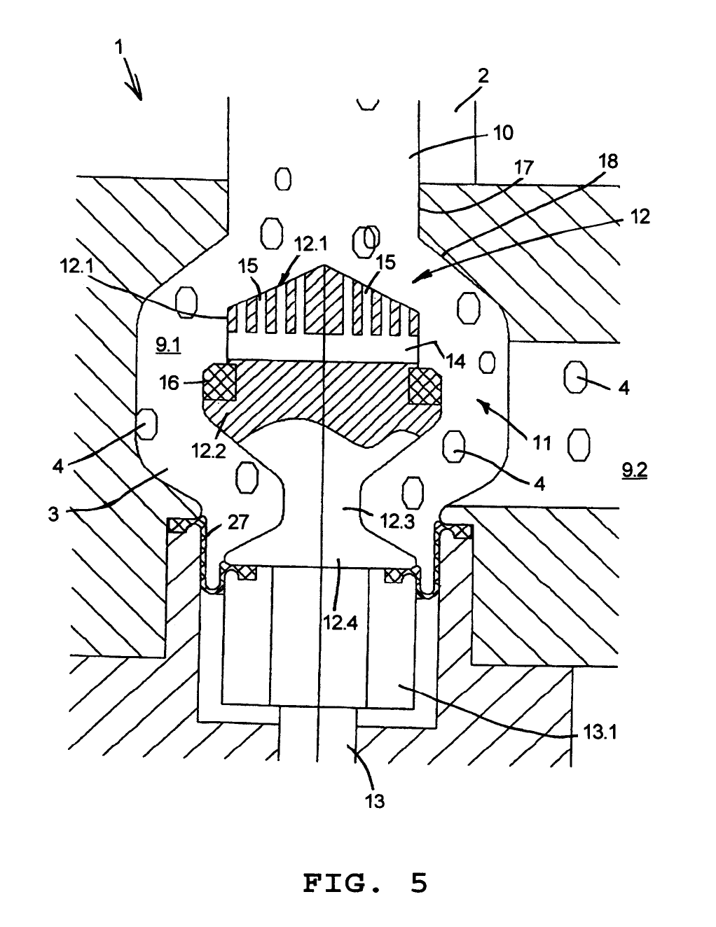

As shown in FIGS. 5 through 7, the valve body 12 is realized as a mushroom head or mushroom cap having a valve body section 12.1 that in the figures forms the free top end of the valve body 12 and which tapers conically toward this end; a valve body section 12.2 adjoining the valve body section 12.1 and having a larger outside diameter than the valve body section 12.1. That side of the valve body section 12.2 facing away from the valve body section 12.1 tapers to a blunt cone and transitions into a valve body section 12.3, which has a reduced outside diameter relative to the sections 12.1 and 12.2 and adjoins a valve body section 12.4, with which the valve body 12 is connected to the plunger 13 or a plunger head 13.1 on the plunger 13. The valve body 12 and its sections 12.1 through 12.4 are rotationally symmetrical to the plunger axis SA.

In other words, and in accordance with at least one possible embodiment according to the present application, the valve body 12 is divided into four sections, 12.1, 12.2, 12.3, and 12.4. Each of these four sections 12.1, 12.2, 12.3, and 12.4 are aligned coaxially, i.e. having the same vertical axis. Each of these four sections 12.1, 12.2, 12.3, and 12.4 has a different diameter. Valve body section 12.4 is adjacent and/or connected to a plunger 13 and/or a plunger head 13.1. The portion of valve body section 12.4 which is furthest from the plunger 13 and/or plunger head 13.1 tapers to meet valve body section 12.3. The valve body section 12.3 has a smaller diameter than the two adjacent valve body sections 12.4 and 12.2. The valve body section 12.2 expands or widens to an outer diameter, which is larger than the diameters of the valve body sections 12.3 and 12.1 adjacent to the valve body section 12.2. The valve body sections 12.4, 12.3, and 12.2 together form a shape that resembles a goblet, martini glass, or otherwise stemmed beverage glass. Valve body section 12.1, which is the free end of the valve body 12, has a smaller diameter than the valve body section 12.2. The portion of the valve body section 12.1 which is furthest from valve body section 12.2, which forms the free end of the valve body 12, tapers to a tip.

In the embodiment shown, the valve body section 12.1 is provided with a channel 14 that runs radially to the plunger axis SA, intersects this axis and is open on both ends and also with a plurality of channels 15, each of which are parallel or virtually parallel to the plunger axis SA and open at the free end of the valve body 12. The channels 15 open into the channel 14 and form a sieve-like structure on the surface of the valve body 12. A seal ring 16 concentric to the plunger axis SA encircles the valve body section 12.2 at the transition to the valve body section 12.1. The channel 14 and plurality of channels 15 form, in one possible embodiment of the present application, a sieve-like structure on the valve body section 12.1.

As is described in greater detail below, the valve body 12 interacts with a valve opening 17 formed by the product channel 9 at the transition to the connecting opening 10 on the one hand, and one the other with a valve seat 18 at the valve opening 17. To this end, the diameter of the valve body section 12.1 is the same or slightly smaller than the diameter of the valve opening 17. The seal ring 16 is arranged such that it sits tightly against the valve seat 18 when the filling valve 11 is closed.

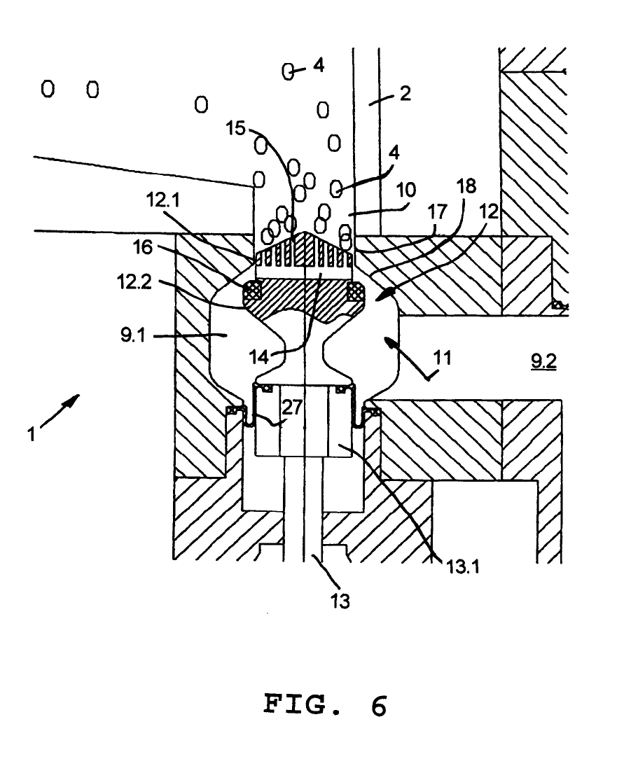

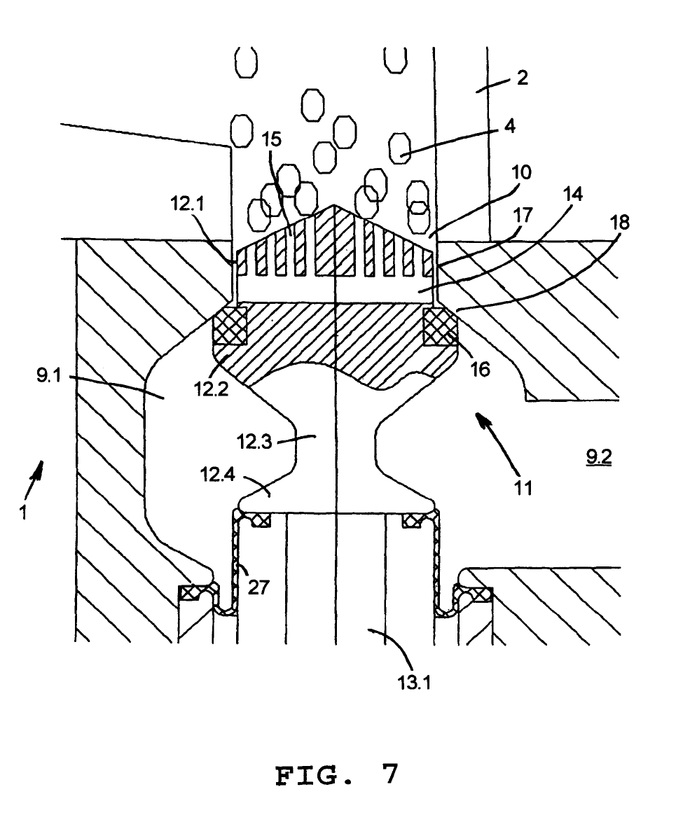

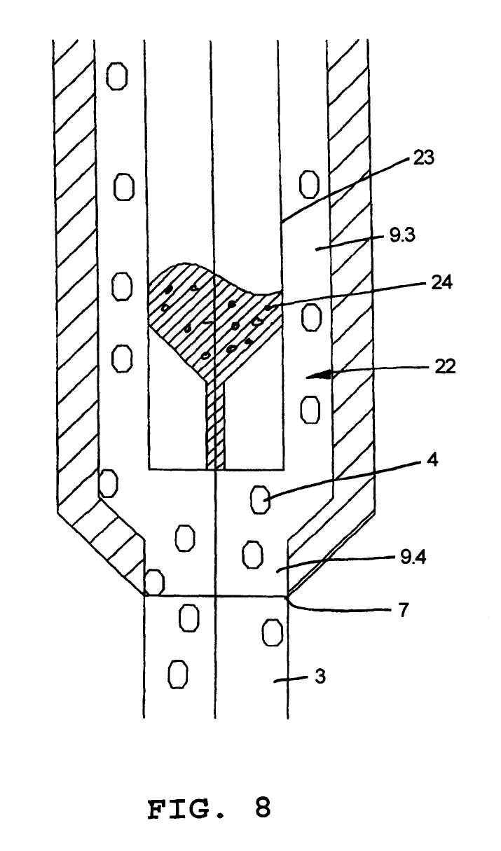

The valve body 12 is actuated pneumatically along the plunger axis SA via the plunger 13 in such a way that the filling valve can assume three different operating states, namely:
as shown in FIG. 5, a fully opened state in which the valve body 12 is at its lowest position with the valve body section 12.1 moved out of the valve opening 17 and at some distance to this valve opening 17;
as shown in FIG. 6, a partly opened state in which the valve body 12 is moved into a partly lifted position and the valve body section 12.1 extends into the valve opening 17, the seal ring 16 is at some distance to the valve seat 18 and the channel 14 opens on both ends into the channel section 9.1; and
as shown in FIG. 7, a fully closed state in which the valve body 12 is moved to its uppermost lift position and rests with the seal ring 16 tightly against the valve seat 18.

The filling valve 11 is therefore opened by moving the valve body 12 vertically downward, and the filling valve 12 is closed by moving the valve body 12 vertically upward.

These movements of the valve body 12 are performed pneumatically. To this end, there is a piston 19.1 on the valve plunger 13, which piston 19.1 together with a cylindrical chamber formed in housing section 8.1 forms an actuating element 19 in the form of a dual-action pneumatic cylinder. Furthermore, a piston 20.1 is provided in housing section 8.1, which piston 20.1 together with an additional cylindrical chamber in housing section 8.1 forms a second actuating element 20 in the form of a pneumatic cylinder, whose piston rod 21 interacts with the lower end of the plunger 13.

In the embodiment shown, actuating element 19 is used to completely open and close the filling valve 11, and actuating element 20 is used to partly open the filling valve 11.

A gas seal or gas trap or gas cutoff element 22 is arranged in channel sections 9.3 and 9.4 in such a manner as to be axially displaceable in the direction of the filling element axis FA. In the embodiment shown, the gas seal 22 comprises a pipe 23 that is arranged coaxial with the filling element axis FA and that is provided with a sieve-like structure formed, for example, by openings 24 in its walls. The sieve-like structure formed by the openings 24 is located in the vicinity of, but at some distance from, the lower end of the pipe 23. The pipe 23 is closed and/or solid, for example, above the openings 24. The outside diameter of the pipe 23 is the same or only slightly smaller than the inside diameter of the channel section 9.4. The cross-section of the openings 24 is chosen such that when the filling valve 11 is closed and the gas seal is in its effective position, the product in the channel section 9.3 is held back by the gas seal 22.

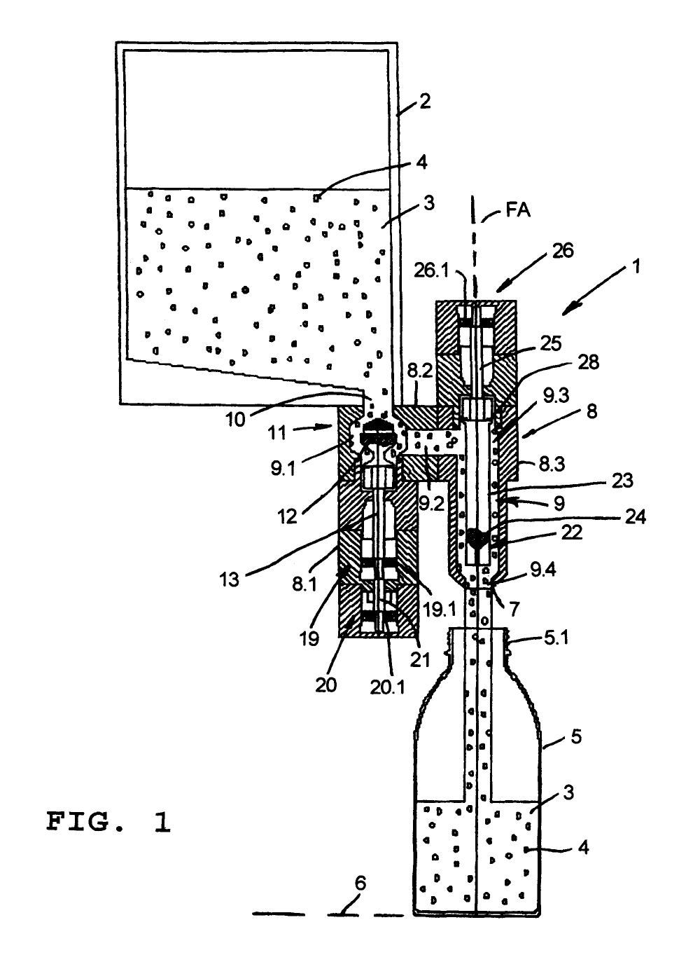

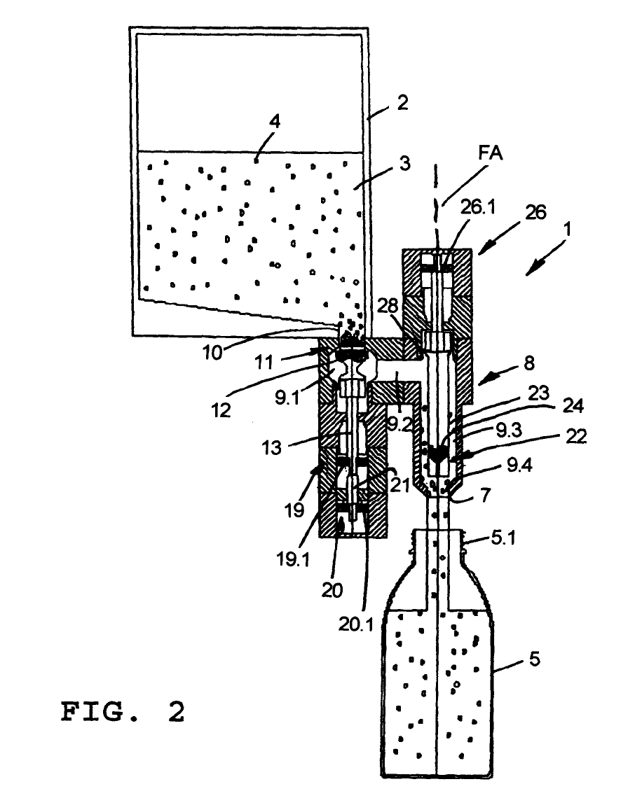

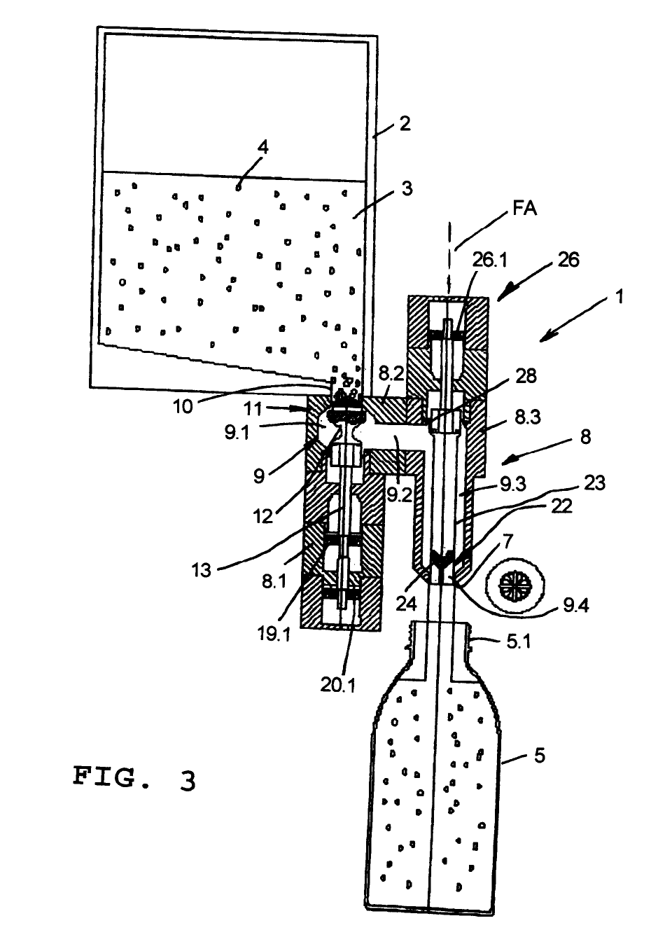

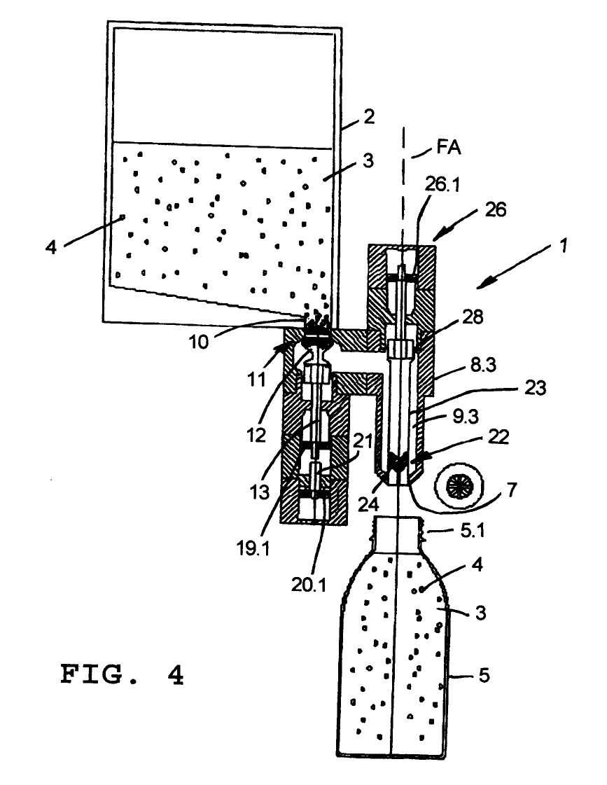

The lower end of a piston rod 25 arranged coaxial with the plunger axis SA is connected to the upper end of the pipe 23. On the piston rod 25, a piston 26.1 of an actuating element 26 in the form of a pneumatic cylinder, by means of which the gas seal 22 is moved by control action between a raised, i.e. non-effective, position in which the lower end of the pipe 23 is, as shown in FIGS. 1 and 2, located inside the channel section 9.3 upstream of the transition to the channel section 9.4 and at some distance thereto, and a lowered, i.e. effective, position in which the lower end of the pipe 23 is fitted into the channel section 9.4 as shown in FIGS. 3 and 4.

The function of the filling element 1 is described below: To initiate the filling process, the initially closed filling valve is opened completely by means of actuating element 19; the gas seal 22, which is initially in its effective position, is lifted, i.e. moved into the non-effective position, by means of the actuating element 26, so that the state of the filling element 1 shown in FIGS. 1 and 5 is achieved and the product 3 together with the more solid components 4 can flow from the discharge opening 7 through the container opening 5.1 and into the container as a free jet.

Prior to the final conclusion of the filling process, i.e. before the final fill level is reached in the container 5, the actuating element 20 is activated and the valve body moved vertically upward so that the filling valve 11 assumes a partly opened position (FIGS. 2 and 6) and the valve body section 12.1 extends into the valve opening 17. In this filling valve 11 state, the liquid product 3 can still flow into the container 5 via the product channel 9 and the discharge opening 7. The components 4 in the product channel are entrained with the liquid product so that the product channel 9 is emptied of these components. The more solid components 4 are retained at the filling valve 11 by the sieve-like valve body section 12.1 so that that they cannot pass into the product channel 9.

In other words and in accordance with at least one possible embodiment according to the present application, there are four stages to filling a container 5 with a liquid product 3 comprising solid components or pieces 4. The first stage of filling involves fully opening the filling valve 11 with the actuating device 19 to allow both the liquid product 3 and the solid components or pieces 4 to flow from the angular vessel 2 and the valve opening 17 into the channel 9. The first stage of filling also involves lifting the gas seal 22 into the non-effective position with the actuating element 26 to allow both the liquid product 3 and the solid components or pieces 4 to flow from the channel 9, through the discharge opening 7, and into the container 5 via of the container opening 5.1.

The second stage of filling involves raising the valve body 12 into the partly opened state with the actuating device 20. In this partly opened state, the valve body section 12.1 is partially inserted into the valve opening 17 so that the channel 14 is below the valve opening 17. This state allows just the liquid product 3 to flow into the channel 9 via the channels 15 and 14. The solid components or pieces 4 cannot flow through the channels 15 and are therefore retained in the annular vessel 2. As just the liquid products 3 flows through the channel 9, the solid components or pieces 4 in the channel 9 are carried along in the flow. Any solid components or pieces 4 in the channel 9 are emptied into the container 5 in this stage.

The third stage of filling involves moving the gas seal 22 into the effective position with the actuating element 26. The filling valve 11 remains in the partly opened state. During this stage of filling, only the liquid product 3 flows from the annular vessel 2, into the channel 9, and through the gas seal 22 into the container 5 via the container opening 5.1.

The fourth stage of filling involves closing the filling valve 11 with the actuating element 19 so that the entire valve body section 12.1 is inserted into the valve opening 17 and the valve body 12 rests with the seal ring 16 tightly against the valve seat 18. With the filling valve 11 in this fully closed state, no product 3 and no solid components or pieces 4 flow from the annular vessel 2 into the channel 9. The gas seal 22 remains in the effective position. Without flow from the annular vessel 2 through the channel 9, the liquid product 3 already in the channel 9 is retained in the channel 9 by the gas seal 22 without or with virtually no dripping and/or leaking. In this fourth state of filling, no or virtually no liquid product 3 or solid components or pieces 4 flow through the discharge opening 7 and into the container 5 via a container opening 5.1. The channel 9 remains filled with liquid product 3 to restrict or minimize any delay in the filling process. The first through fourth stages are repeated to fill additional containers 5 with liquid products 3 and solid components or pieces 4.

After the product channel 9 is emptied of the more solid components 4, the gas seal 22 is moved via the actuating element 26 from its non-effective position into the effective position while the filling valve 11 remains in the partly opened position. The filling process continues via the partly opened filling valve 11, the product channel 9 and the gas seal 22, which is now located at the discharge opening 7, until the desired fill level in the container 5 is reached. This state is shown in FIGS. 3 and 6.

To end the filling process, the filling valve 11 is closed by the actuating element 19 while the gas seal 22 remains in the effective position. This stops the discharge of product 3 to the container 5. The product channel 9 and in one possible embodiment the channel section 9.3 remain filled with liquid product 3. The gas seal 22 in its effective position retains the liquid product in the channel section 9.3 and also restricts or minimizes the filling element from dripping.

The unusual feature of the filling element 1 thus lies in the fact that the design and special actuation of the valve body 12 enables the filling of a product 3 with more solid components 4 without the more solid components 4 getting stuck between the valve body 12 and the valve seat 18 when closing the filling valve. The components 4 are also restricted from getting stuck between the gas seal 22 and the inside surface of the filling element 1 when moving the gas seal 22 from the non-effective position to the effective position. The liftable/lift-out design of the gas seal 22 is what makes it possible to use a gas seal and enjoy the associated advantages thereof while filling the product 3 with more solid components 4.

In other words and in accordance with at least one possible embodiment of the present application, the openings 24 have a sufficiently small diameter, which restricts or minimizes any dripping or leaking of product 3 from the filling element 1. A sufficient surface tension of product 3 and a sufficient surface area of the gas trap to effectively restrict or minimize leaking while also restricting or minimizing gas from flowing into the channel 9.

These advantages include the avoidance of dripping from the filling element when the filling valve 11 is closed and in the fact that at the start of each filling process, i.e. before the actual opening of the filling valve 11, the product channel 9 is already filled with the liquid product, so that the respective filling process can be initiated without delay. With the appropriate design, in one possible embodiment of housing section 8.3, it is also possible to provide a flowmeter at channel section 9.3 so that the filling process can be controlled on the basis of the product quantity.

Membrane seals 27 and 28 seals the product channel 9 in the vicinity of the filling valve 11 and/or the vicinity of the valve plunger 13 located there, as well as in the vicinity of the pipe 23.

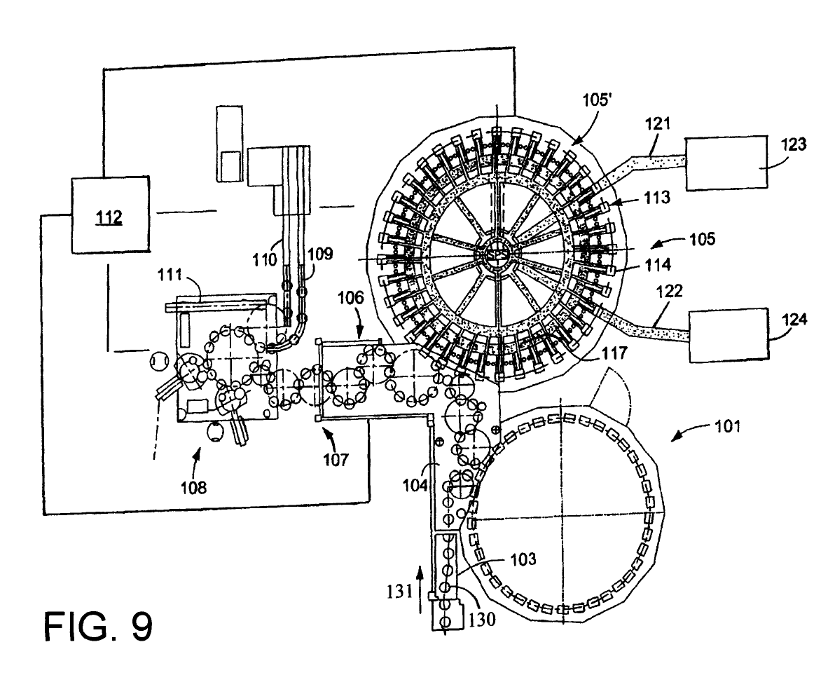

FIG. 9 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 9, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 is connected by a starwheel conveyer structure to three output conveyer arrangements: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

The present application was described above with reference to one possible embodiment. It will be understood that numerous modifications and derivations are possible without departing from the teaching on which the present application is based.

The present application relates to a filling element for the filling of product, in one possible embodiment a product having more solid components in a liquid phase, said element having a product channel configured in a housing, which channel can be connected at one end to a reservoir for the product and which forms at the other end a discharge opening for discharging the product into a container, said element also having in the product channel a filling valve which can be moved between a closed state and an opened state by means of an actuating element.

One feature or aspect of an embodiment is believed at the time if the filing of this patent application to possibly reside broadly in a filling element for the filling of a product, in one possible embodiment a product that in a liquid phase comprises more solid components, having at least one product channel 9 in a housing 8, which channel 9 can be connected via an inlet opening on one end to a reservoir 2 for the product and has at the other end a discharge opening 7 for the discharge of the product into a container 5, whereby the filling element 1 can be positioned by control action between an initial operating state that restricts or minimizes the discharge of product and a second opened operating state, wherein the filling element 1 has in addition to the first and second operating states a third operating state in which it is opened for the discharge of the liquid phase of the product but the solid components 4 are retained.

Another feature or aspect of an embodiment is believed at the time if the filing of this patent application to possibly reside broadly in the filling element, comprising a gas seal 22 located in the product channel 9 that can be moved by control action between an effective and a non-effective position by means of an actuating element 26.

One feature or aspect of an embodiment is believed at the time if the filing of this patent application to possibly reside broadly in the filling element for the filling of a product, in one possible embodiment a product that in a liquid phase comprises more solid components, having at least one product channel 9 in a housing 8, which channel 9 can be connected via an inlet opening on one end to a reservoir 2 for the product and has at the other end a discharge opening 7 for the discharge of the product into a container 5, whereby the filling element 1 can be positioned by control action between an initial operating state that restricts or minimizes the discharge of product and a second opened operating state, comprising a gas seal 22 located in the product channel 9 that can be moved by control action between an effective and a non-effective position by means of an actuating element 26.

Another feature or aspect of an embodiment is believed at the time if the filing of this patent application to possibly reside broadly in the filling element, wherein the filling element 1 has in addition to the first and second operating state a third operating state, in which it is open for the discharge of the liquid phase of the product, but the solid components 4 are retained.

Yet another feature or aspect of an embodiment is believed at the time if the filing of this patent application to possibly reside broadly in the filling element, wherein the at least one product channel 9 or one valve configuration 11 in the at least one product channel 9 can be moved by control action between the first, second and third operating state.

Still another feature or aspect of an embodiment is believed at the time if the filing of this patent application to possibly reside broadly in the filling element, comprising at least one actuating element 19, 20 at the filling element 1 to control the operating states of the filling element 1 and/or to control the at least one product channel 9 or the valve configuration 11.

A further feature or aspect of an embodiment is believed at the time if the filing of this patent application to possibly reside broadly in the filling element, wherein the valve configuration comprises at least one filling valve 11.

Another feature or aspect of an embodiment is believed at the time if the filing of this patent application to possibly reside broadly in the filling element, wherein the filling valve 11 has at least one valve body 12 that can be moved by control action between at least two and often between at least three positions by means of at least one actuating element 19, 20 to alter the operating state of the filling element 1.

Yet another feature or aspect of an embodiment is believed at the time if the filing of this patent application to possibly reside broadly in the filling element, wherein the valve body 12 in the first operating state of the filling element 1 rests with a seal surface 16 against a valve seat 18 surrounding a valve opening 17 and in the second operating state of the filling element 1 is at some distance from the valve seat 18, and that the valve body 12 has a valve body section 12.1 that in the third operating state of the filling element 1 extends into the valve opening 17 and forms a barrier for the retention of the more solid components 4 of the product at the valve opening 17.

Still another feature or aspect of an embodiment is believed at the time if the filing of this patent application to possibly reside broadly in the filling element, wherein the valve body section 12.1 forms a sieve-like structure 14, 15.

A further feature or aspect of an embodiment is believed at the time if the filing of this patent application to possibly reside broadly in the filling element, wherein in the third operating state of the filling valve 11, the valve body section 12.1 together with a boundary surface of the valve opening 17 forms a reduced cross-section outlet and/or a sieve-like structure for the retention of the solid components 4.

Another feature or aspect of an embodiment is believed at the time if the filing of this patent application to possibly reside broadly in the filling element, wherein the valve body 12 can be moved in one single axial direction between positions corresponding to the various operating states of the filling element 1.

Yet another feature or aspect of an embodiment is believed at the time if the filing of this patent application to possibly reside broadly in the filling element, wherein the valve body 12 can be moved a full stroke between the first and second operating state of the filling element 1, and a partial stroke between the first and the third and/or the second and the third operating state of the filling element 1, respectively.

Still another feature or aspect of an embodiment is believed at the time if the filing of this patent application to possibly reside broadly in the filling element, wherein the valve body is moved against the direction of product flow when closing the filling element 1 or when switching the filling element 1 from the second operating state to the third operating state.

A further feature or aspect of an embodiment is believed at the time if the filing of this patent application to possibly reside broadly in the filling element, wherein the valve body 12 can be moved in the axial direction of the valve opening 17.

Another feature or aspect of an embodiment is believed at the time if the filing of this patent application to possibly reside broadly in the filling element, wherein the valve opening 17 is oriented with its axis vertical or nearly vertical.

Yet another feature or aspect of an embodiment is believed at the time if the filing of this patent application to possibly reside broadly in the filling element, wherein the valve opening 17 is the inlet opening of the product channel 9.

Still another feature or aspect of an embodiment is believed at the time if the filing of this patent application to possibly reside broadly in the filling element, wherein the gas seal 22 is located in the vicinity of the discharge opening 7 or in the vicinity of a channel section 9.4 of the product channel 9 that forms the discharge opening.

A further feature or aspect of an embodiment is believed at the time if the filing of this patent application to possibly reside broadly in the filling element, wherein the gas seal 22 occupies the entire flow cross-section of the product channel 9 when in the effective position, and when in the non-effective position occupies a portion of the flow cross-section or is located entirely outside of the product channel 9.

Another feature or aspect of an embodiment is believed at the time if the filing of this patent application to possibly reside broadly in the filling element, wherein the gas seal 22 is located in the vicinity of the discharge opening 24 or in the vicinity of a channel section 9.4 of the product channel 9 that forms the discharge opening.

Yet another feature or aspect of an embodiment is believed at the time if the filing of this patent application to possibly reside broadly in the filling element, wherein the gas seal in the effective position extends into an area of reduced cross-section or channel section 9.4 of the product channel 9, and in the non-effective position is located in a channel section 9.3 of the product channel 9 having an enlarged cross-section.

Still another feature or aspect of an embodiment is believed at the time if the filing of this patent application to possibly reside broadly in the filling element, wherein the channel section 9.4 with the reduced cross-section forms the discharge opening 7.

A further feature or aspect of an embodiment is believed at the time if the filing of this patent application to possibly reside broadly in the filling element, wherein the gas seal 22 can be moved from the non-effective position into the effective position in an axial direction corresponding to the direction of flow of the product through the product channel 9.

Another feature or aspect of an embodiment is believed at the time if the filing of this patent application to possibly reside broadly in the filling element, wherein the gas seal 22 can be moved from the non-effective position into the effective position along the axis of the discharge opening 7.

Yet another feature or aspect of an embodiment is believed at the time if the filing of this patent application to possibly reside broadly in the filling element, wherein the gas seal 22 is formed by a pipe 23 having a sieve-like plurality of openings 24 on its circumference.

Still another feature or aspect of an embodiment is believed at the time if the filing of this patent application to possibly reside broadly in the filling element, wherein two actuating elements 19, 20 are provided for the actuation of the filling valve 11 or the valve body 12, one actuating element 19 of which serves the selection of the first and second operating states and the second actuating element 20 serves the selection of the third operating state.

A further feature or aspect of an embodiment is believed at the time if the filing of this patent application to possibly reside broadly in the filling element, wherein the at least one actuating element 19, 20 for the filling valve 11 and/or for the gas seal 22 are pneumatically powered elements.

Another feature or aspect of an embodiment is believed at the time if the filing of this patent application to possibly reside broadly in the filling machine, in one possible embodiment a rotary-type filling machine with a plurality of filling elements, wherein the filling elements are designed according to the present application.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, which were cited in the International Search Report dated Dec. 4, 2007, and/or cited elsewhere are hereby incorporated by reference as if set forth in their entirety herein as follows: EP 0546347, having the following English translation of the German title “FILLING HEAD WITH A GAS BARRIER IN THE FORM OF A HORIZONTALLY GROOVED BELL,” published on Jun. 16, 1993; U.S. Pat. No. 7,011,117, having the title “FILLING VALVE,” published on Mar. 14, 2006; DE 2246176, having the German title “DOSIERVENTIL,” published on Apr. 11, 1974; and EP 1577259, having the following English translation of the German title “BEVERAGE BOTTLING PLANT FOR FILLING BOTTLES WITH A LIQUID BEVERAGE MATERIAL HAVING A BOTTLE FILLING MACHINE WITH A FILLING VALVE FOR FILLING BOTTLES WITH A LIQUID BEVERAGE,” published on Sep. 21, 2005.

The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 025 229.2, filed on May 29, 2006, having inventors Volker TILL and Dieter-Rudolf KRULITSCH, and DE-OS 10 2006 025 229.2 and 10 2006 025 229.2, and International Application No. PCT/EP2007/004504, filed on May 22, 2007, having WIPO Publication No. WO 2007/137727 and inventors Volker TILL and Dieter-Rudolf KRULITSCH, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/004504 and German Patent Application 10 2006 025 229.2 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/004504 and DE 10 2006 025 229.2 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Filling element
2 Annular vessel
3 Product
4 More solid components or pieces in the product
5 Container
5.1 Container opening
6 Container conveyor
7 Discharge opening
8 Housing of the filling element 1
8.1, 8.2, 8.3 Housing section
9 Product channel in housing 8
9.1, 9.2, 9.3 Channel section
10 Connecting opening in annular vessel 2 for filling element 1
11 Filling valve
12 Valve body
12.1, 12.2, 12.3, 12.4 Valve body section
13 Plunger
13.1 Plunger head
14, 15 Channel
16 Seal ring
17 Valve opening
18 Valve face or valve seat
19 Actuating element
19.1 Piston
20 Actuating element
20.1 Piston
21 Piston rod
22 Gas trap
23 Pipe
24 Opening
25 Piston rod
26 Actuating element
26.1 Piston
27, 28 Membrane seal

What is claimed is:

1. A method of operating a filling machine in a container filling plant, said filling machine being configured to fill containers with a fruit juice and fruit pulp, said filling machine comprising: a reservoir being configured and disposed to hold a supply of fruit juice and fruit pulp; at least one reservoir opening being configured and disposed to permit the flow of fruit juice and fruit pulp; at least one filling element being configured and disposed to fill containers with fruit juice and fruit pulp; said at least one filling element comprising: a housing; a filling valve being configured and disposed to permit or restrict the flow of fruit juice from said at least one reservoir opening and to permit or restrict the flow of fruit pulp from said at least one reservoir opening; a first actuating arrangement being configured and disposed to partially close said filling valve to permit flow of fruit juice and to restrict the flow of fruit pulp; a second actuating arrangement being configured and disposed to fully close said filling valve to restrict the flow of fruit juice and fruit pulp and to fully open said filling valve to permit the flow of fruit juice and fruit pulp; a channel being configured and disposed to receive fruit juice and fruit pulp from said filling valve; said channel comprising a discharge opening being configured and disposed to permit flow of fruit juice and fruit pulp from said channel to a container; a gas cutoff element being configured and disposed to minimize dripping and/or leaking of fruit juice from said discharge opening upon fruit juice not being discharged from said discharge opening; and a third actuating arrangement being configured and disposed to move said gas cutoff element into said discharge opening;
said method comprising the steps of:
disposing a container under said discharge opening at a distance to allow gas from said container to flow out of said container as filling takes place;
opening said filling valve with said second actuating arrangement to permit the flow of fruit juice and fruit pump from said reservoir to said channel;
moving said gas cutoff element out of said discharge opening to permit the flow of fruit juice and fruit pulp from said channel through said discharge opening to said container;
partially closing said filling valve with said first actuating arrangement to permit the flow of fruit juice from said reservoir to said channel while substantially simultaneously restricting the flow of fruit pulp from said reservoir to said channel;
flowing fruit juice without pulp through said channel and flushing fruit pulp out of said channel and into said container;
disposing said gas cutoff element to minimize dripping and/or leaking of fruit juice from said discharge opening upon fruit juice not being discharged from said discharge opening;
closing said filling valve with said second actuating arrangement and restricting the flow of fruit juice and fruit pulp from said reservoir to said channel; and
minimizing dripping and/or leaking of fruit juice, with said gas cutoff element, from said discharge opening upon fruit juice not being discharged from said discharge opening.

2. The method according to claim 1, wherein said third actuating arrangement is further configured to:
move said gas cutoff element into said discharge opening to minimize dripping and/or leaking upon fruit juice not being discharged from said discharge opening; and
move said gas cutoff element out of said discharge opening to permit the flow of fruit juice and fruit pulp.

3. The method according to claim 2, wherein said first actuating arrangement and said second actuating arrangement are configured to control the flow of both fruit juice and fruit and fruit juice without pulp in said filling valve and said channel.

4. The method according to claim 3, said filling machine further comprising all of (A), (B), (C), (D), (E), (F), (G), (H), (I), (J), (K), (L), (M), (N), (O), (P), and (Q) wherein:
(A) said filling valve comprises at least one valve configured to:
permit the flow of a fruit juice and fruit pulp upon being opened;
permit the flow of fruit juice while restricting the flow of fruit pulp upon being partially closed; and
restrict the flow of both fruit juice and fruit pulp upon being fully closed;
(B) said at least one valve comprises as least one valve body;
said at least one valve body is configured and disposed to be moved by said first actuating element and said second actuating element;
said first actuating element and said second actually the element are configured to:
open said at least one valve body to permit the flow of fruit juice and fruit pulp;
partially close said at least one valve body to permit the flow of fruit juice while restricting the flow of fruit pulp; and
fully close said at least one valve body to restrict either the flow of a fruit juice and fruit pulp or fruit juice;
(C) said valve body section comprises a sieve-like structure configured to permit the flow of fruit juice while restricting the flow of fruit pulp;
(D) said sieve-like structure partially blocks said valve opening upon said filling valve being partially closed, to permit the flow of fruit juice while restricting the flow of fruit pulp;
(E) said gas cutoff element is disposed in said channel and adjacent to said discharge opening;
(F) said first actuating element is configured to:
open said filling valve to permit the flow of fruit juice and fruit pulp; and
fully close said filling valve to restrict both the flow of fruit juice and fruit pulp and fruit juice without pulp; and
said second actuating element is configured to partially close said filling valve to permit the flow of fruit juice while restricting the flow of fruit pulp;
(G) said third actuating element is configured to move said gas cutoff element in the direction of flow toward said discharge opening upon moving said gas cutoff element into said discharge opening;
(H) said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said second actuating element is configured to partially close said filling valve to permit the flow of fruit juice while restricting the flow of fruit pulp;
said third actuating element is configured to move said gas cutoff element in the direction of flow toward said discharge opening upon said third actuating element moving said gas cutoff element into said discharge opening;
(I) said gas cutoff element comprises a pipe;
said pipe comprises a pipe circumference;
said pipe comprises a portion having a plurality of openings;
(J) said valve body is configured to be moved, by said second actuating element, a first distance between an open position and a fully closed position;
said valve body is further configured to be moved, by said first actuating element, a second distance between an open position and a partially closed position;
said second distance is substantially less than said first distance;
(K) said valve body is further configured to move against the direction flow of both fruit juice and fruit pulp and fruit juice without pulp upon said filling valve being either partially closed or fully closed;
(L) said filling valve further comprises:
a seal ring being disposed on each of said at least one valve body;
a valve opening being disposed adjacent to said reservoir opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said filling valve being fully closed, to restrict both the flow of fruit juice and fruit pulp and fruit juice without pulp;
said valve body section is configured to be disposed a distance from said valve seat, upon said filling valve being opened, to permit the flow of fruit juice and fruit pulp;
said valve body section is configured to be inserted into said valve opening and said seal ring is configured to be disposed a distance from said valve seat, upon said filling valve being partially opened to permit the flow of fruit juice while restricting the flow of fruit pulp;
(M) said valve body comprises a longitudinal axis;
said valve body is configured to be moved along the longitudinal axis;
(N) said valve opening comprises a valve opening longitudinal axis;
said the valve body is configured to be moved along said valve opening longitudinal axis;
(O) valve opening longitudinal axis is disposed vertically;
(P) said valve opening comprises an inlet of said channel;
said channel comprises a channel longitudinal axis;
said third actuating element is configured to move said gas cutoff element along said channel longitudinal axis; and
(Q) said first actuating element and said second actuating element comprise pneumatically powered actuated elements.

5. A filling machine in a container filling plant being configured to fill containers with a liquid having solid components, said filling machine comprising:
a reservoir being configured and disposed to hold a supply of a liquid having solid components;
at least one reservoir opening being configured and disposed to permit the flow of a liquid having solid components;
at least one filling element being configured and disposed to fill containers with a liquid having solid components;
said at least one filling element comprising:
a housing;
a valving arrangement being configured and disposed to permit or restrict the flow of a liquid from said at least one reservoir opening and to permit or restrict the flow of solid components from said at least one reservoir opening;
a channel being configured and disposed to receive a liquid having solid components from said valving arrangement;
said channel comprising a discharge opening being configured and disposed to permit flow of a liquid having solid components from said channel to a container;
a gas cutoff element being configured and disposed to minimize dripping and/or leaking of a liquid from said discharge opening upon liquid not being discharged from said discharge opening;
an actuating arrangement being configured to:
open said valving arrangement to permit the flow of a liquid having solid components;
partially close said valving arrangement to permit the flow of a liquid while restricting the flow of solid components;
fully close said valving arrangement to restrict the flow of either a liquid having solid components or a liquid without substantial solid components;
move said gas cutoff element into said channel to minimize dripping and/or leaking upon liquid not being discharged from said discharge opening; and
move said gas cutoff element out of said channel to permit the flow of a liquid having solid components.

6. The filling machine according to claim 5, wherein said actuating arrangement:
is further configured to move said gas cutoff element into said discharge opening to minimize dripping and/or leaking upon liquid not being discharged from said discharge opening;
is further configured to move said gas cutoff element out of said discharge opening to permit the flow of a liquid having solid components;
comprises at least one actuating element configured to control the flow of either a liquid having solid components or a liquid without substantial solid components in said valving arrangement and said channel;
said valving arrangement comprises at least one valve configured to:
permit the flow of a liquid having substantial solid components upon being opened;
permit the flow of a liquid without substantial solid components while restricting the flow of solid components upon being partially closed; and
restrict the flow of both a liquid having substantial solid components and a liquid without solid components upon being fully closed;
said at least one valve comprises as least one valve body;
said at least one valve body is configured and disposed to be moved by said at least one actuating element;
said at least one actuating element is configured to:
open said at least one valve body to permit the flow of a liquid having solid components;
partially close said at least one valve body to permit the flow of a liquid while restricting the flow of solid components; and
fully close said at least one valve body to restrict either the flow of a liquid having solid components or a liquid without substantial solid components.

7. The filling machine according to claim 6, wherein:
said gas cutoff element is disposed in said channel and adjacent to said discharge opening;
said valve body section comprises a sieve-like structure configured to permit the flow of a liquid without substantial solid components while restricting the flow of solid components; and
said sieve-like structure partially blocks said valve opening upon said valving arrangement being partially closed, to permit the flow of a liquid while restricting the flow of solid components;
said at least one actuating element comprises a first actuating element configured to:
open said valving arrangement to permit the flow of a liquid having solid components; and
fully close said valving arrangement to restrict either the flow of a liquid having solid components or a liquid without substantial solid components; and
said at least one actuating element further comprises a second actuating element configured to partially close said valving arrangement to permit the flow of a liquid while restricting the flow of solid components; and
said at least one actuating element is configured to move said gas cutoff element downstream in the direction of flow towards said discharge opening upon said gas cutoff element being moved, by said at least one actuating element, into said discharge opening.

8. The filling machine according to claim 7, wherein:
said gas cutoff element is configured to restrict the flow of a liquid having solid components upon said gas cutoff element being disposed in said discharge opening;
said gas cutoff element is configured to permit the flow of a liquid having solid components upon said gas cutoff element being moved out of said discharge opening and moved into said channel;
said gas cutoff element comprises a pipe;
said pipe comprises a pipe circumference; and
said pipe comprises a portion having a plurality of openings.

9. The filling machine according to claim 8, wherein:
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance; and
said valve body is further configured to move against the direction of flow of either a liquid having solid components or a liquid without substantial solid components upon said valving arrangement being either partially closed or fully closed.

10. The filling machine according to claim 9, said filling machine further comprising one of: (A), (B), (C), (D), (E), (F), (G), (H), (I), (J), (K), (L), (M), (N), (O), and (P), wherein:
(A) said valve body section comprises a sieve-like structure configured to permit the flow of a liquid without substantial solid components while restricting the flow of solid components;
(B) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
(C) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
(D) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
(E) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
(F) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
(G) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
(H) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
(I) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
(J) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
valve body is further configured to move against the direction flow of either a liquid having solid components or a liquid without substantial solid components upon said valving arrangement being either partially closed or fully closed;
(K) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
valve body is further configured to move against the direction flow of either a liquid having solid components or a liquid without substantial solid components upon said valving arrangement being either partially closed or fully closed;
said valving arrangement further comprises:
a seal ring being disposed on each of said at least one valve body;
a valve opening being disposed adjacent to said reservoir opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said valving arrangement being fully closed, to restrict either the flow of a liquid having solid components or a liquid without substantial solid components;
said valve body section is configured to be disposed a distance from said valve seat, upon said valving arrangement being opened, to permit the flow of a liquid having solid components;
said valve body section is configured to be inserted into said valve opening and said seal ring is configured to be disposed a distance from said valve seat, upon said valving arrangement being partially opened to permit the flow of a liquid while restricting the flow of solid components;
(L) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
valve body is further configured to move against the direction flow of either a liquid having solid components or a liquid without substantial solid components upon said valving arrangement being either partially closed or fully closed;
said valving arrangement further comprises:
a seal ring being disposed on each of said at least one valve body;
a valve opening being disposed adjacent to said reservoir opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said valving arrangement being fully closed, to restrict either the flow of a liquid having solid components or a liquid without substantial solid components;
said valve body section is configured to be disposed a distance from said valve seat, upon said valving arrangement being opened, to permit the flow of a liquid having solid components;
said valve body section is configured to be inserted into said valve opening and said seal ring is configured to be disposed a distance from said valve seat, upon said valving arrangement being partially opened to permit the flow of a liquid while restricting the flow of solid components;
said valve body comprises a longitudinal axis;
said valve body is configured to be moved along the longitudinal axis;
(M) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
valve body is further configured to move against the direction flow of either a liquid having solid components or a liquid without substantial solid components upon said valving arrangement being either partially closed or fully closed;
said valving arrangement further comprises:
a seal ring being disposed on each of said at least one valve body;
a valve opening being disposed adjacent to said reservoir opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said valving arrangement being fully closed, to restrict either the flow of a liquid having solid components or a liquid without substantial solid components;
said valve body section is configured to be disposed a distance from said valve seat, upon said valving arrangement being opened, to permit the flow of a liquid having solid components;
said valve body section is configured to be inserted into said valve opening and said seal ring is configured to be disposed a distance from said valve seat, upon said valving arrangement being partially opened to permit the flow of a liquid while restricting the flow of solid components;
said valve body comprises a longitudinal axis;
said valve body is configured to be moved along the longitudinal axis;
said valve opening comprises a valve opening longitudinal axis;
said the valve body is configured to be moved along said valve opening longitudinal axis;
(N) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
valve body is further configured to move against the direction flow of either a liquid having solid components or a liquid without substantial solid components upon said valving arrangement being either partially closed or fully closed;
said valving arrangement further comprises:
a seal ring being disposed on each of said at least one valve body;
a valve opening being disposed adjacent to said reservoir opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said valving arrangement being fully closed, to restrict either the flow of a liquid having solid components or a liquid without substantial solid components;
said valve body section is configured to be disposed a distance from said valve seat, upon said valving arrangement being opened, to permit the flow of a liquid having solid components;
said valve body section is configured to be inserted into said valve opening and said seal ring is configured to be disposed a distance from said valve seat, upon said valving arrangement being partially opened to permit the flow of a liquid while restricting the flow of solid components;
said valve body comprises a longitudinal axis;
said valve body is configured to be moved along the longitudinal axis;
said valve opening comprises a valve opening longitudinal axis;
said the valve body is configured to be moved along said valve opening longitudinal axis;
valve opening longitudinal axis is disposed vertically;
(O) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
valve body is further configured to move against the direction flow of either a liquid having solid components or a liquid without substantial solid components upon said valving arrangement being either partially closed or fully closed;
said valving arrangement further comprises:
a seal ring being disposed on each of said at least one valve body;
a valve opening being disposed adjacent to said reservoir opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said valving arrangement being fully closed, to restrict either the flow of a liquid having solid components or a liquid without substantial solid components;
said valve body section is configured to be disposed a distance from said valve seat, upon said valving arrangement being opened, to permit the flow of a liquid having solid components;
said valve body section is configured to be inserted into said valve opening and said seal ring is configured to be disposed a distance from said valve seat, upon said valving arrangement being partially opened to permit the flow of a liquid while restricting the flow of solid components;
said valve body comprises a longitudinal axis;
said valve body is configured to be moved along the longitudinal axis;
said valve opening comprises a valve opening longitudinal axis;
said the valve body is configured to be moved along said valve opening longitudinal axis;
valve opening longitudinal axis is disposed vertically;
said valves opening comprises an inlet of said channel;
said channel comprises a channel longitudinal axis;
said at least one actuating element is configured to move said gas cutoff element along said channel longitudinal axis; and
(P) said valve body section comprises a sieve-like structure configured to permit the flow of a liquid without substantial solid components while restricting the flow of solid components;
said sieve-like structure partially blocks said valve opening upon said valving arrangement being partially closed, to permit the flow of a liquid while restricting the flow of substantial solid components;
said gas cutoff element is disposed in said channel and adjacent to said discharge opening;
said at least one actuating element comprises a first actuating element configured to:
open said valving arrangement to permit the flow of a liquid having solid components; and
fully close said valving arrangement to restrict both the flow of a liquid having solid components or a liquid without substantial solid components; and
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
said gas cutoff element comprises a pipe;
said pipe comprises a pipe circumference;
said pipe comprises a portion having a plurality of openings;
said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
valve body is further configured to move against the direction flow of either a liquid having solid components or a liquid without substantial solid components upon said valving arrangement being either partially closed or fully closed;
said valving arrangement further comprises:
a seal ring being disposed on each of said at least one valve body;
a valve opening being disposed adjacent to said reservoir opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said valving arrangement being fully closed, to restrict either the flow of a liquid having solid components or a liquid without substantial solid components;
said valve body section is configured to be disposed a distance from said valve seat, upon said valving arrangement being opened, to permit the flow of a liquid having solid components;
said valve body section is configured to be inserted into said valve opening and said seal ring is configured to be disposed a distance from said valve seat, upon said valving arrangement being partially opened to permit the flow of a liquid while restricting the flow of solid components;
said valve body comprises a longitudinal axis;
said valve body is configured to be moved along the longitudinal axis;
said valve opening comprises a valve opening longitudinal axis;
said the valve body is configured to be moved along said valve opening longitudinal axis;
valve opening longitudinal axis is disposed vertically;
said valves opening comprises an inlet of said channel;
said channel comprises a channel longitudinal axis;
said at least one actuating element is configured to move said gas cutoff element along said channel longitudinal axis; and
said first actuating element and said second actuating element comprise pneumatically powered actuated elements.

11. A filling element being configured to fill containers with a liquid having solid components, said filling element comprising:
a housing;
a valving arrangement being configured and disposed to permit or restrict the flow of a liquid and to permit or restrict the flow of solid components;
a channel being configured and disposed to receive a liquid having solid components from said valving arrangement;
said channel comprising a discharge opening being configured and disposed to permit flow of a liquid having solid components from said channel to a container;
a gas cutoff element being configured and disposed to minimize dripping and/or leaking of a liquid from said discharge opening upon liquid not being discharged from said discharge opening;
an actuating arrangement being configured to:
open said valving arrangement to permit the flow of a liquid having solid components;
partially close said valving arrangement to permit the flow of a liquid and to restrict the flow of solid components;
fully close said valving arrangement to restrict the flow of either a liquid having solid components or a liquid without solid components;
move said gas cutoff element into said channel to minimize dripping and/or leaking upon liquid not being discharged from said discharge opening; and
move said gas cutoff element out of said channel to permit the flow of a liquid having solid components.

12. The filling element according to claim 11, wherein said actuating arrangement is further configured to:
move said gas cutoff element into said discharge opening to minimize dripping and/or leaking upon liquid not being discharged from said discharge opening; and
move said gas cutoff element out of said discharge opening to permit the flow of a liquid having solid components.

13. The filling element according to claim 12, wherein said actuating arrangement comprises at least one actuating element configured to control the flow of either a liquid having solid components or a liquid without substantial solid components in said valving arrangement and said channel.

14. The filling element according to claim 13, wherein said valving arrangement comprises at least one valve configured to:
permit the flow of a liquid having substantial solid components upon being opened;
permit the flow of a liquid without substantial solid components while restricting the flow of solid components upon being partially closed; and
restrict the flow of both a liquid having solid components and a liquid without solid components upon being fully closed.

15. The filling element according to claim 14, wherein:
said at least one valve comprises as least one valve body;
said at least one valve body is configured and disposed to be moved by said at least one actuating element;
said at least one actuating element is configured to:
open said at least one valve body to permit the flow of a liquid comprising solid components;
partially close said at least one valve body to permit the flow of a liquid while restricting the flow of solid components; and
fully close said at least one valve body to restrict both the flow of a liquid having solid components and a liquid without substantial solid components.

16. The filling element according to claim 15, wherein said valve body section comprises a sieve-like structure configured to permit the flow of a liquid without substantial solid components while restricting the flow of solid components.

17. The filling element according to claim 16, wherein said sieve-like structure partially blocks said valve opening upon said valving arrangement being partially closed, to permit the flow of a liquid while restricting the flow of substantial solid components.

18. The filling element according to claim 17, wherein said gas cutoff element is disposed in said channel and adjacent to said discharge opening.

19. The filling element according to claim 18, wherein:
said at least one actuating element comprises a first actuating element configured to:
open said valving arrangement to permit the flow of a liquid comprising solid components; and
fully close said valving arrangement to restrict both the flow of a liquid comprising solid components or a liquid without substantial solid components; and
said at least one actuating element further comprises a second actuating element configured to partially close said valving arrangement to permit the flow of a liquid while restricting the flow of substantial solid components.

20. The filling element according to claim 19, comprising all of (A), (B), (C), (D), (E), (F), (G), (H), (I), (J), and (K) wherein:
(A) said at least one actuating element is configured to move said gas cutoff element in the direction of flow toward said discharge opening upon moving said gas cutoff element into said discharge opening;
(B) said channel comprises a channel circumference;
said channel tapers to form said discharge opening;
said discharge opening comprises a discharge opening circumference;
said discharge opening circumference is smaller than said channel circumference;
said gas cutoff element comprises a circumference similar to said discharge opening circumference;
said at least one actuating element further comprises a second actuating element configured to partially close said valving arrangement to permit the flow of a liquid while restricting the flow of substantial solid components;
said at least one actuating element is configured to move said gas cutoff element in the direction of flow toward said discharge opening upon moving said gas cutoff element into said discharge opening;
(C) said gas cutoff element comprises a pipe;
said pipe comprises a pipe circumference;
said pipe comprises a portion having a plurality of openings;
(D) said valve body is configured to be moved, by said at least one actuating element, a first distance between an open position and a fully closed position;
said valve body is further configured to be moved, by said at least one actuating element, a second distance between an open position and a partially closed position;
said second distance is substantially less than said first distance;
(E) valve body is further configured to move against the direction flow of either a liquid comprising solid components or a liquid without substantial solid components upon said valving arrangement being either partially closed or fully closed;
(F) said valving arrangement further comprises:
a seal ring being disposed on each of said at least one valve body;
a valve opening;
a valve seat being disposed adjacent to said valve opening; and
a valve body section being disposed on said at least one valve body adjacent to said seal ring and closer to said valve seat than said seal ring;
said seal ring is configured to rest against said valve seat, upon said valving arrangement being fully closed, to restrict either the flow of a liquid comprising solid components or a liquid without substantial solid components;
said valve body section is configured to be disposed a distance from said valve seat, upon said valving arrangement being opened, to permit the flow of a liquid comprising solid components;
said valve body section is configured to be inserted into said valve opening and said seal ring is configured to be disposed a distance from said valve seat, upon said valving arrangement being partially opened to permit the flow of a liquid while restricting the flow of solid components;
(G) said valve body comprises a longitudinal axis;
said valve body is configured to be moved along the longitudinal axis;
(H) said valve opening comprises a valve opening longitudinal axis;
said the valve body is configured to be moved along said valve opening longitudinal axis;
(I) valve opening longitudinal axis is disposed vertically;
(J) said valves opening comprises an inlet of said channel;
said channel comprises a channel longitudinal axis;
said at least one actuating element is configured to move said gas cutoff element along said channel longitudinal axis; and
(K) said first actuating element and said second actuating element comprise pneumatically powered actuated elements.
